(19) United States
(12) Patent Application Publication
(10) Pub. No.: US 2024/0186027 A1
(43) Pub. Date: Jun. 6, 2024

(54) Complex Artificial Electromagnetic Field Array for Particle Fusion, Confinement, to Yield Larger Elements

(71) Applicants: Olatunbosun Osinaike, Pleasant Prairie, WI (US); Olatunde Osinaike, Atlanta, GA (US); Olajuwon Osinaike, Denver, CO (US); Peter Patterson, Mount Pleasant, WI (US)

(72) Inventors: Olatunbosun Osinaike, Pleasant Prairie, WI (US); Olatunde Osinaike, Atlanta, GA (US); Olajuwon Osinaike, Denver, CO (US); Peter Patterson, Mount Pleasant, WI (US)

(21) Appl. No.: 18/527,333

(22) Filed: Dec. 3, 2023

Related U.S. Application Data
(63) Continuation of application No. 18/074,469, filed on Dec. 3, 2022.

(51) Int. Cl. G21B 1/23

(52) U.S. Cl. CPC G21B 1/23

(57) ABSTRACT

This patent application is a disclosure detailing electromagnetic wave arrays utilized to encourage fusion of subatomic particles, quarks, into desired elements. It utilizes a variation of approaches to stacking electromagnetic waves as vectors in an array, resembling Lagrangian points of stability in an orbit, as well as transformations of that array, to achieve fusion of subatomic particles into larger elements.

### CROSS REFERENCE TO RELATED APPLICATION

This patent disclosure is a continuation patent application of an earlier filed patent application, application Ser. No. 18/074,469, filed Dec. 3, 2022.

### BACKGROUND OF THE INVENTION

This patent application is a utility patent application in the field of fusion, electromagnetism. This is a continuation patent application.

### BRIEF SUMMARY OF THE INVENTION

This application applies to arrangements of electromagnetic radiation that encourages the fusion of subatomic quarks into a desired element, by utilizing electromagnetic waves, in a vector array utilizing points of stability in an orbit, resembling Lagrange points, where the structure is a stable rotational base for electrons in the electron shell configuration.

### DESCRIPTION OF DRAWINGS

FIG. 1: This image is an example of a mirror Lagrange, where a mirror of the weighted Lagrangian triangle, is imposed on the original, and the S shell, L1 L2, occupy an approximate location to the L3 of the mirror formation. The balance yields a six location array, a hexagon, where 2 of the 6 corners has 3 targets each, and 4 of the six locations, have one target. Each target can have 2 electromagnetic waves projected at it, or potentially more.

FIG. 2: In a mirror Lagrange, the smaller sets of three may be arranged in a line, with equidistant separation between each set of three, or a staggered formation which mimics the centrifugal three of the standard Lagrange 5 point array. This second image demonstrates a mirror Lagrange, with a staggered set of L1, L2, L3. The second drawing demonstrates how the L1, L2 may be separated from the L3, to form a more exact mirror image. The targets are defined as the locations that accept opposite projections of polarized electromagnetic radiation, wherein the circular electric field induces electron spin, and may represent a central target, array of targets and the center of the energy-mass system.

FIG. 3: This third image is a Diamond Shell configuration, which places 4 additional target locations in between the S shell, L1-L2, and the L4, L5. The L4 and L5 are balanced on the Coriolis Force and have a wider base. They also share a radius with the L3. The L3 shares a radius with L4, L5, as well a linear axis, on occasion, with the L1, L2. The L1, L2, L4, L5 may welcome additional four targets in their proximity, to open eight additional electromagnetic field vectors for the next row in the periodic table, where each target represents a subshell, with opposite or same spin electric field vectors.

FIG. 4: The fourth image is a Diamond Shell configuration, where the S1, S2 and analogous L1, L2 are positioned in such a way, relative to the additional 4 targets, that half of the four additional targets, are on either side of the innermost L1. Thus, there are five targets to the left of both the L1, L2, and three targets to the right of the innermost L1, including the L2, and the two additional targets. As a result, there are ten vectors, two from each target, to the left of the L1 electric field vectors, and six to the right of the L1 vectors.

FIG. 5: The fifth image accentuates, enhances, the space between the four additional target vectors, 2 on either side of the innermore L1 target, so that the three targets to the right of the L1: L2, L8, L9 branch outward, in a more true mirror of the L1, L6, and L7.

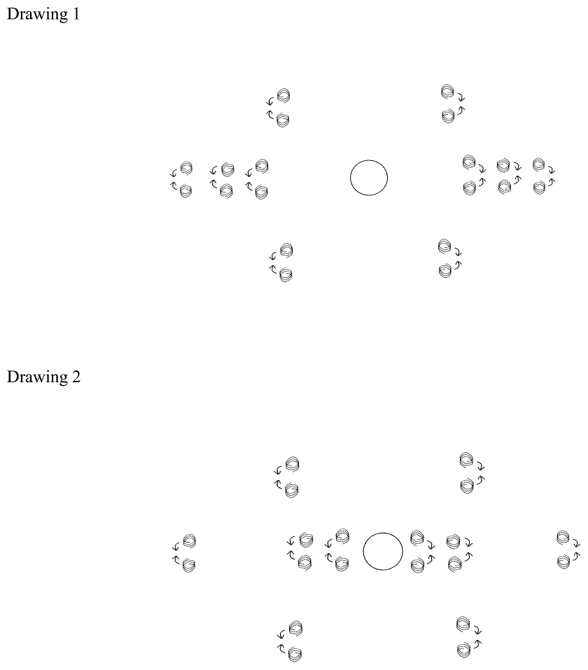

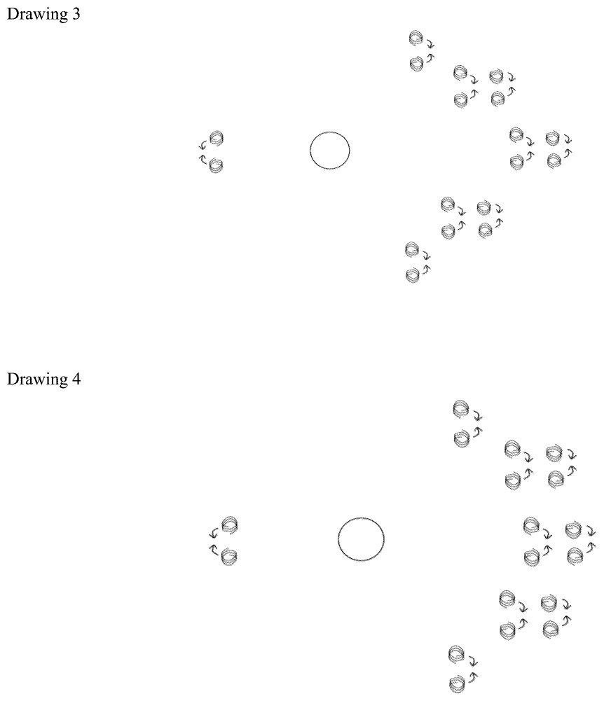

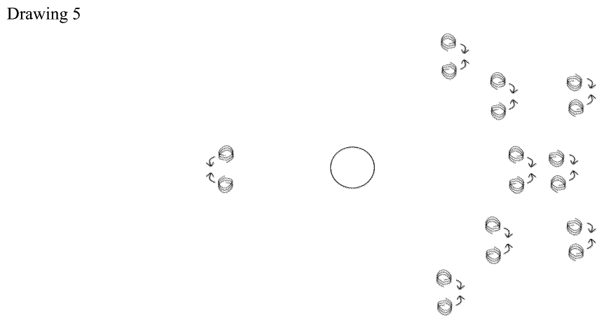

### DETAILED DESCRIPTION OF THE INVENTION

An array of electromagnetic radiation can be utilized to encourage the fusion of subatomic particles, quarks, as the gravitational stability of Lagrange in a rotating frame of reference, enables a vector approach for the placement of electric fields, that encourage fusion of quarks into a count of protons and neutrons, which fit the electron shell being mimicked by electric field vectors within polarized projections of light.

The L1, L2 are analogous with the S1 S2/1S 2S subshells of the electron shell configuration. The quarks that compose the proton, neutron, nucleus of an atom have partial charges, which is a reflection of a Lagrange-like weighted vector.

The Lagrange-like array of electromagnetic waves, circularly or linearly polarized, can be utilized to encourage the fusion of atoms on a planetary scale, inside a planet, or in the atoms surrounding a planet, as well as fusing atoms when enough energy is applied to an energy-mass target. An energy-mass target may be the size of a planet, the size of a pellet, or the size of an atom, with a large range in between.

Using the Lagrange points between a planet and its moon, the electric fields emerging from these gravitational points of stability act as a base for the partial charge necessary for quark arrangement into larger nuclei supported by the electron shell.

The motion of the electromagnetic field array around a planet may encourage fusion within an electrically conductive mass, which, in combination with the moon's tidal forces, may encourage electromagnetic stimulation of a dynamo-generated electromagnetic field, similar to Earth's. Projecting electromagnetic waves at the Lagrange points of a planet and its moon, may help restart or restrengthen the planet's magnetic field.

Electromagnetic waves projected from, or towards Lagrange points may be off-target vectors, that are affected by the gravitational curvature of space time, which can be caused by mass or energy concentration.

The electromagnetic array that encourages fusion of subatomic quarks may be focused on a singular mass-energy, a two mass-energy system, a five mass-energy system, a nine mass-energy system, or an equivalent amount of targets around a multiple or singular focus mass-energy system. In pursuit of heavier elements, more additional target locations may be utilized for the additional electron shell orbits.

The array may be focused around a central target, or group of targets, corresponding either to the mass focal points of a two body orbit, or the gravitational points of stability around a two body orbit.

The array may be utilized in a region of space that has high flow of electric current, or energy-mass density, such as the heliospheric and galactic current sheet.

A mirrored array is a double Lagrange array, where one Lagrange mirrors the other, and the two arrays are imposed on the original 5 target Lagrange structure, such that the centrifugal L1, L2, L3, which are in line with one another, bunch into two groups of three. The L4 and L5 utilized opposite sides, creating a hexagon, where two of the six locations have 3 targets.

A Diamond Shell expansion, uses the L3 as a sort of eigenvector. There are 4 additional targets added to the original 5, in proximity to the L1, L2, L4, L5, to create electric field vectors for the next row in the periodic table. The four targets allow for eight more electric field vectors within the 8 electromagnetic waves imposed on the four new target locations. These four targets are placed on the heavier side of the original Lagrange five, leaving the L3 isolated in its half, and imposing 4 new targets between, or around the wider Coriolis L4 and L5 spots, and the S shell corresponding L1 and L2 spots.

This diamond shell expansion, which has nine targets, the original Lagrangian orbital 5, and 4 new, can be transformed, rotated on an axis, to give an additional 9 target locations, 18 electromagnetic field vectors for the next row in the periodic table. This diamond shell 2-8-8, may be rotated on an axis, such that the new plane contains an intersecting line along the linear convergence of the centrifugal L1, L2, L3. In some transformations, the targets may overlap in the same location. The electromagnetic field vectors, would branch out in a different dimension.

The entire array could also be rotated so that the L1, and L2 groups are not convergent, but exist on different planes. The angle between each plane of targets may be modified to specific angles, such as 60 degrees, 108 degrees, 120 degrees, etc. The transformation, rotation converts the original 9 targets, 2-8-8 electric field count, to a vector field that contains an additional 9 targets, 18 electric field vectors. This type of transformation, the rotation of a nine target array, would be utilized to fuse particles into heavier atoms.

There are multiple ways to add four targets, eight electromagnetic field vectors, such as demonstrated in FIG. 5. The new four targets may be placed between the L4, L5, and L1. The new four targets may all fall in between the L4, L5, L1 focal points. The new four targets may also be split in groups of two, where two are on either side of the L1, the innermost target of the 1S, 2S. Thus, there are five total targets, up to 10 electric field vectors to one side of the L1, and three targets, up to six electric field vectors to the opposite side of the L1, with the vectors on L2 being counted in the minority group, and the vectors of L4 and L5, being counted in the majority group. The placement of the outermost pair of additional targets may also be placed outside the entire group, as opposed to forming a line in between L1, L2, such that the group of five and group of three expand in opposite directions.

A second orbital radius may also be utilized to establish a second Lagrangian set with a larger orbital radius around a target, a planet, or ignition focal point. This would be used to take advantage of Lagrange points for Mars' multiple moons: Deimos and Phobos.

A singular wave, or pair of electromagnetic waves may also be projected through the line containing centrifugal three of the Lagrangian five: L1, L2, L3. These waves may have opposite or symmetric circular, linear polarization. Entanglement can occur when an electromagnetic wave passes through a crystal. Lagrangian points of orbital stability are like a crystal, and with the Diamond Shell expansion, and can be augmented to further resemble a crystal, by adding new target locations for electromagnetic field vectors to pass through.

A coil may be wrapped around a fusion target, or set of targets, in order to encourage the flow of electric current around a set of target focal points, a modified circuit that maintains the flow of current through the electromagnetic array configuration.

This process may be enhanced by acoustic levitation, a soundwave shelf generated in a reaction chamber, or at different altitudes near Lagrangian orbitals, to expand an electric plane of stability into a third dimension. The soundwave shelf helps sustain the electric current by creating more planes of orbital stability above and beneath the target plane for electric vectors. It may also act as a shelf, a limit to sustain the current in 3 dimensions, and maintain current flow after powering down the artificial electromagnetic vectors.

1. Process to encourage fusion of subatomic quarks, comprising
a. Projecting an array of electromagnetic waves towards, at, along or from target, or set of targets
b. Where the focal point(s) of the array comprise a Lagrangian orbital balance
c. With five central targets,
d. Where up to two electromagnetic waves are projected at each target, with opposite or symmetric circular polarization
e. Around a central ignition point, or a group of focus ignition points

2. Process to encourage fusion of subatomic quarks, comprising
a. Projecting an array of electromagnetic waves towards, at, along or from target, or set of targets
b. Where the focal point(s) of the array comprise a Lagrangian orbital balance
c. With nine central targets, adding four targets to the five from the traditional Lagrange weighted triangle
d. Where up to two electromagnetic waves are projected at each target, with opposite or symmetric circular polarization
e. Around a central ignition point, or a group of focal ignition points

3. Process to terraform planet, comprising
a. Projecting an array of electromagnetic waves towards, at, along or from target, or set of targets
b. Where the target focal points are at Lagrange points of a two-body orbit, or an energy-mass target system with Lagrangian balance,
c. And projection of electromagnetic waves encourages fusion in a planet's core, charging or restarting the planet's magnetic field
